(19) United States
(12) Patent Application Publication
(10) Pub. No.: US 2008/0126331 A1
(43) Pub. Date: May 29, 2008

(54) System and method for ranking reference documents

(75) Inventor: Michael D. Shepherd, Ontario, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/510,345

(22) Filed: Aug. 25, 2006

(51) Int. Cl. G06F 7/06

(52) U.S. Cl. 707/5; 707/E17.014

(57) ABSTRACT

A method for knowledge mining a set of documents, wherein each particular document of the set of documents has been assigned a score based upon how many documents reference the particular document, is disclosed. The method includes entering search criteria into the knowledge mining application which then uses the search criteria to identify documents that match the search criteria within the set of documents, and receiving a list of the identified documents, wherein the list of identified documents are ranked by their score.

The embodiments disclosed herein are directed to document retrieval methods and more specifically to methods for weighting the results of a search.

As the World Wide Web and other repositories of knowledge increase their semantic capabilities, robust schemes for knowledge mining automatically provide references to relevant documentation in specific areas of knowledge. Document references are common in research and academic papers, but the documents being referenced are typically not aware of those documents that reference them. Shared knowledge between the documents does not, by itself, provide enough information regarding the strength of the documents semantic commonality. Document references provide additional information about the strength of their shared knowledge, but this is not currently captured in the emerging semantic technologies for documents.

Documents contain information such as, for example, semantics. The combination of semantic queries into a knowledge-base of documents with a weighted reference network greatly enhances the ability of any knowledge mining application to acquire meaningful query results.

What is proposed is a mechanism for tracking the list of referencing documents and the resulting count of referencing documents for each referenced document in a repository of documents. A knowledge mining application then leverages the count and weightings of referencing documents to determine the strength of relevance to the information being queried. For each document in the repository, the count of documents referencing that document may be stored or created to form a ‘reference network’. Such a knowledge mining application combines the semantics of queries with the strengths and weightings of resulting document set in combination with the reference network to prioritize and recommend the most relevant documents.

Embodiments include a knowledge base containing a set of documents, wherein at least some of the documents are referenced by other documents and wherein each referenced document is associated with a score based upon the number of other documents that reference the referenced document.

Embodiments also include a method for knowledge mining a set of documents, wherein each particular document of the set of documents has been assigned a score based upon how many documents reference the particular document. The method includes entering search criteria into the knowledge mining application which then uses the search criteria to identify documents that match the search criteria within the set of documents, and receiving a list of the identified documents, wherein the list of identified documents are ranked by their score.

Various exemplary embodiments will be described in detail, with reference to the following figures.

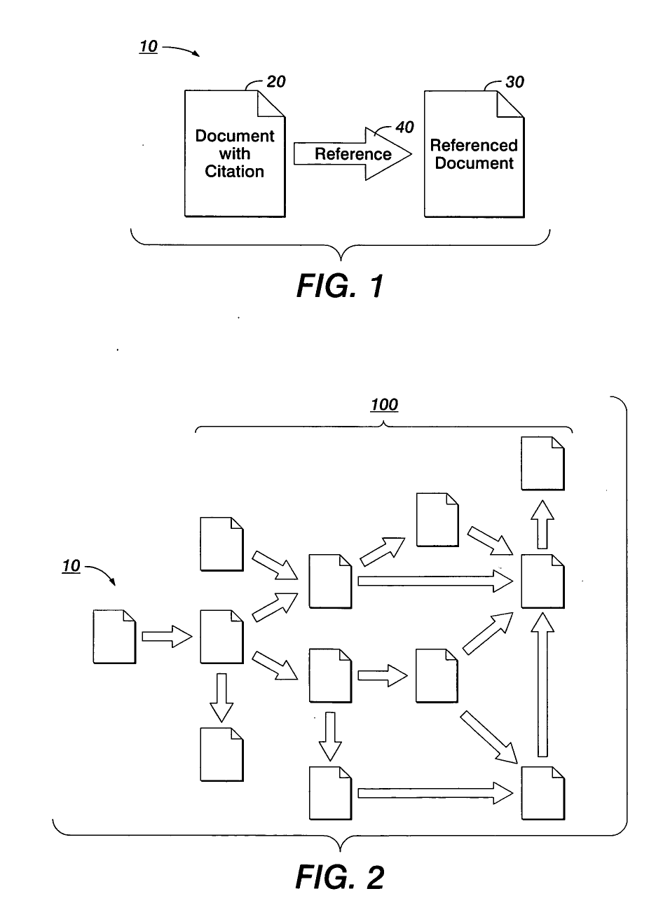

FIG. 1 schematically illustrates the relationship between a referencing document and a referenced document.

FIG. 2 is a schematic illustration of an example of a reference network.

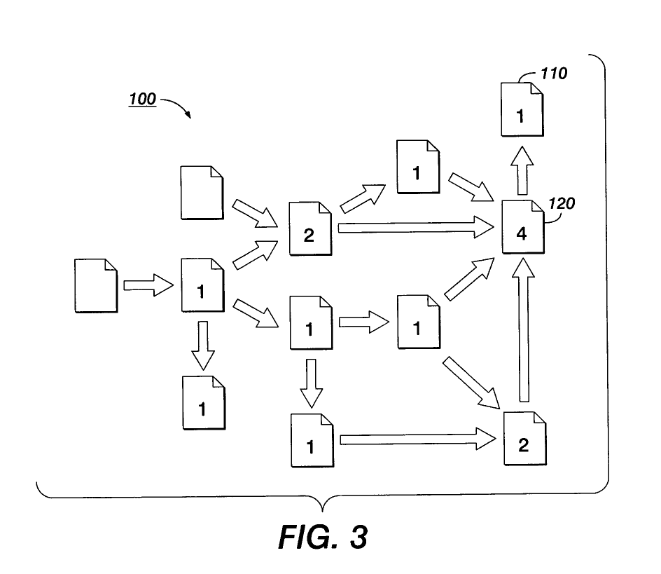

FIG. 3 is a schematic illustration of an example of a weighted reference network with level-1 weighting.

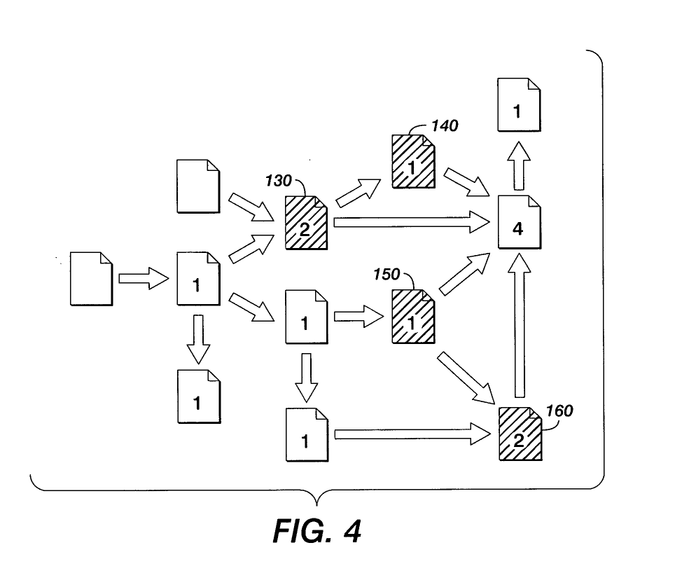

FIG. 4 shows the reference network of FIG. 3 with several documents marked for semantic relevance.

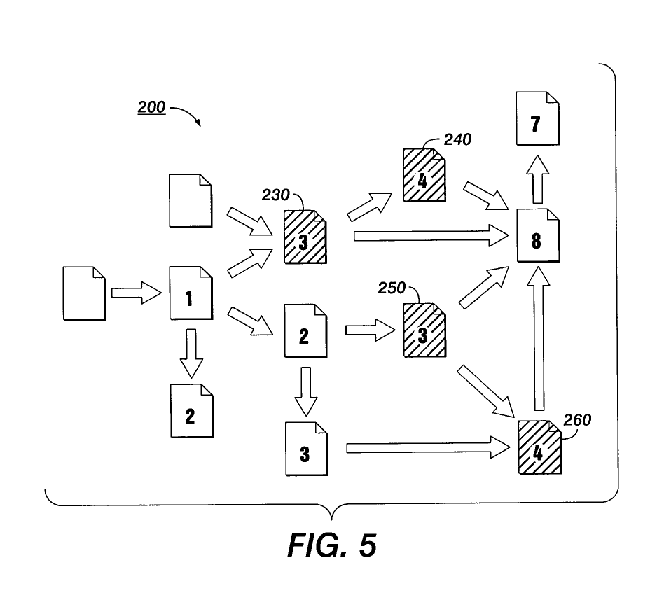

FIG. 5 is a schematic illustration of an example of a weighted reference network with level-3 weighting.

A document as referred to herein includes one or more pages of data that can be embodied physically and/or electronically, such as a file in a database or a webpage. A document can include, for example, images and/or text.

A knowledge-base is a term used to describe a database that contains a set of documents that a human or automated agent can query for information. A knowledge base may be a closed or open set of documents. For example, a knowledge-base may be a closed collection of files stored in a database at a particular site, or web pages on a closed intranet. An example of an open knowledge base would be the World Wide Web, where web pages would be the individual documents constituting that database.

Documents within a knowledge-base may reference other documents in the knowledge-base. In embodiments, when an author of a document makes reference to another document in the knowledge-base, the referenced document logs a pointer to the referencing document. FIG. 1 schematically illustrates a first document 20 referencing a second document 30 within knowledge base 10. A reference arrow 40 is shown pointing to the referenced document 30 from the referencing document 20. In embodiments, reference relationships between documents may be stored along with the documents themselves. For example, they can be stored in a centralized document manager or added to each referenced (or referencing) document itself.

A reference network describes the reference relationships among a set of documents. A knowledge-base may contain one or more reference networks of the documents stored therein. FIG. 2 shows a graphical representation of a reference network 100 for a set of documents stored in knowledge base 10. When the knowledge-base stores reference relationships in a centralized fashion, a persistent reference network may be stored in a document manager. When the knowledge-base stores documents in a decentralized manner, each document may contains its own list of referencing documents and a virtual reference network is dynamically built through monitoring and/or querying the documents' referencing lists.

Knowledge mining applications could use referencing information to prioritize, sort, or filter results. A knowledge mining application could detect and evaluate the referencing information for a document or group of documents in a variety of ways. The referencing information may, for example, be detectable as metadata associated with each referenced document in a knowledge base. For hypertext (or other dynamic language) documents, a knowledge mining application may detect active links in referencing documents in a defined group of documents being searched. Such information would be used by the knowledge mining application to build a reference network. Alternatively, the knowledge base may simply include a centralized document manager containing referencing information between documents, which may or may not be in reference network format.

Not all references in a reference network may be equally useful, or relevant. The references in a reference network can be weighted based upon a variety of criteria. One manner of weighting the documents in a reference network is by weighting the vertexes of the network so that each referenced document node contains the number of documents referencing that document node. For example, as shown in FIG. 3, the knowledge base 10 can include a reference network 100 for referenced document 110. Each document in the reference network 100 is assigned a weight value based upon the number of documents directly referencing that document. Typically, this weight value will be assigned by the mining application based upon the detected reference values; although it's possible the assignment of weight values could be part of the function of the database itself. Document 110 has a weight score of 1 because only 1 document, document 120, directly references document 110. Document 120 is assigned a weight of 4 because 4 documents reference that document. In the example shown in FIG. 3, the weight scores for each document only count the documents that directly reference the referenced document. This can be referred to as a level-1 reference weighting system.

The scores associated with each document would typically be calculated by the knowledge mining application.

FIG. 4 helps illustrate how the weighted reference network may be used. A knowledge mining application may query documents in the knowledge-base for their semantic content. For example, a user may search the reference network of documents using key words or phrases to find documents dealing with a specific topic. FIG. 4 illustrates the exemplary reference network of FIG. 3 with semantically relevant documents shaded. As shown in FIG. 4, the application may discover that a set of documents 130, 140, 150, 160 has semantic relevance to the query. The weightings and/or positions of these documents in the reference network can be used to prioritize these documents such that the knowledge-base responds to the querying application with an ordered list of relevant documents. For example, documents 130 and 160 may be considered higher priority documents because they each have weighted values of 2, while documents 140 and 150 have weighted values of 1. The knowledge mining application may rank documents 130 and 160 first and second on a list of results presented to the user.

The weighting may also consider each document's position in the network—e.g., all documents that indirectly reference the referenced document up to a certain depth N in the graph are counted for the weighting. A weighting of level-N means that there are up to an N depth of vertices used to count the number of documents that directly or indirectly reference the document. This is called a reference network with level-N weighting in which N can be set to produce an optimal weighting to express a document's relative relevance. This scalable adjust of weighting allows knowledge-base queries to be more tailorable and effective.

FIG. 5 illustrates a reference network 200 similar to that of FIG. 4 and having the same documents, except that level-3 weight scores have been applied. Each document's weight score is the sum of all the documents directly referencing a referenced document (first order referencing documents), all the documents directly referencing the first order referencing documents (second order referencing documents), and all the documents directly referencing the second order referencing documents.

Applying the same knowledge mining operation as was applied to the reference network of FIG. 4 to the knowledge base containing reference network 200, an analogous set of documents 230, 240, 250, 260 are flagged by the knowledge mining application. In FIG. 5, using the level-3 weight scores would reprioritize the documents. Documents 240 and 260 have weight scores of 4, while documents 230 and 250 have weight scores of 3. Therefore, the query response would prioritize the documents with a weight of 4 higher than those documents with a weight of 3. The output from the knowledge mining application might list documents 240 and 260 first and second on a list of results presented to the user.

As the preceding examples indicate, the priority of relevance changes with the selected level of weighting.

Other, more complex methods of weighting documents based upon direct and indirect references made to those documents may be used as well. For example, higher order references, i.e., indirect references, to a document may be identified as contributing less to a document's relevance than direct references. If such were the case, each second order referencing document could be counted as one half a point, for example. Further, each third order reference could be counted as a one third of a point, etc.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A knowledge base containing a set of documents, wherein at least: some of the documents are referenced by other documents and wherein each referenced document is associated with a score based upon the number of other documents that reference the referenced document.

2. The knowledge base of claim 1, wherein each referenced document's score is based solely upon the number of documents that directly reference the referenced document.

3. The knowledge base of claim 1, wherein each referenced document's score is based upon the total number of documents that directly and indirectly reference the referenced document.

4. The method of claim 1, wherein the documents are web pages.

5. A method for knowledge mining a set of documents, comprising:
entering search criteria into a knowledge mining application which then uses the search criteria to identify documents that match the search criteria within the set of documents; and
receiving a list of the identified documents,
wherein the list of identified documents are ranked by a weighted reference score assigned to each identified document, and
wherein the weighted reference score for each particular document is based upon how many documents reference the particular document.

6. The method of claim 5, further comprising assigning each identified document a score based upon how many documents reference the particular document.

7. The method of claim 5, wherein each document in the set of documents already has a weighted reference score at the time the knowledge mining is performed.

8. The method of claim 5, wherein the search criteria includes semantic criteria.

9. The method of claim 5, wherein the weighted reference score is based upon how many documents directly reference the particular document.

10. The method of claim 5, wherein the weighted reference score is based upon how many documents directly and indirectly reference the particular document.

11. The method of claim 5, wherein the set of documents are a set of web pages.

12. A knowledge mining application that receives criteria for searching a set of documents, identifies a set of result documents within the set of documents that match the criteria, assigns a score to each result document based upon the number of documents that reference that result document, and ranks the order of the search results based upon the assigned score.

13. A method for searching a set of documents, comprising:
receiving search criteria;
identifying documents that match the search criteria;
assigning a weighted reference score to each identified document, wherein the weighted reference score is based upon the number of documents in the set of documents that reference the identified document; and
generating a list of the identified documents,
wherein the set of documents are ranked according to each document's assigned weighted reference score.

14. The method of claim 13, further comprising generating a reference network for the set of documents.

15. The method of claim 13, wherein the search criteria includes semantic criteria.

16. The method of claim 13, wherein the weighted reference score is based upon how many documents directly reference the particular document.

17. The method of claim 13, wherein the weighted reference score is based upon how many documents directly and indirectly reference the particular document.

18. The method of claim 13, wherein the set of documents are a set of web pages.
